(19) United States
(12) Patent Application Publication
(10) Pub. No.: US 2023/0356433 A1
(43) Pub. Date: Nov. 9, 2023

(54) A PLANT FOR CONVEYING MATERIAL FOR THE PRODUCTION OF STRUCTURAL CONCRETE AND PROCESS

(71) Applicant: SIMEM S.p.A., Minerbe (IT)

(72) Inventor: Michele Furlani, Minerbe (IT)

(21) Appl. No.: 18/001,944

(22) PCT Filed: Jun. 15, 2021
(86) PCT No.: PCT/IB2021/055262

§ 371 Date: Dec. 15, 2022

(30) Foreign Application Priority Data
Jun. 16, 2020 (IT) 102020000014320

(51) Int. Cl. B28C 7/04; B28C 7/06

(52) U.S. Cl. CPC B28C 7/0422; B28C 7/06

(57) ABSTRACT

A plant for conveying material for the production of structural concrete comprises a first container configured to contain a first amount of material, a first detection member configured to detect a variation in the first amount of material and first release members configured to enable and/or disable release of the first amount of material towards a mixing area of the first amount of material. The plant further comprises a second container configured to contain a second amount of material varying between a second minimum and a second maximum reference amount, a second detection member configured to detect a variation in the second amount of material and second release members configured to enable and/or disable release of the second amount of material towards a mixing area. In particular, an unloading opening of the second container is connected to the mixing area, whereas an unloading opening of the first container is connected to a loading opening of the second container or to a mixing area. A control unit is configured at least to enable said release members to release the first amount of material when the second detection member detects the reaching of the second minimum reference amount in the second container. The present invention also relates to a process for conveying material for the production of structural concrete.

### TECHNICAL FIELD

The present invention relates to a plant for conveying material for the production of structural concrete.

In particular, the invention relates to an optimised plant for conveying materials for the continuous production of certified high quality structural concrete obtained by mixing cement, filler, fly ash, silica, ash, or other powdered materials.

The present invention also relates to a process for conveying material for the production of structural concrete.

A particular application of the invention relates to the sector of concrete, cement mixtures, the production of road foundations and inertisation.

### PRIOR ART

Currently, it is known for concrete to be made or, more generally, conglomerate composite materials to be made using concrete mixing plants configured for continuous mixing.

Such plants, commonly defined as “continuous plants”, comprise a mixer, generally having a tubular shape, continuously supplied with the necessary ingredients for the formation of the desired mixture, the most common of which include cement, water and possibly additives. In particular, the ingredients, which are introduced at a first opening, are advanced and mixed along the entire length of the mixer until reaching a second collection opening.

Therefore, continuous plants enable large productions to be obtained using reduced power levels, as the entire production process is substantially condensed into a single step. Generally, continuous plants are used for producing cement mixtures, road foundations and concrete with low sump factors or in inertisation.

On the contrary, the application of continuous plants does not contemplate the production of structural concrete, which is usually used for the construction of large structural works (apartment blocks, bridges, dams . . . ), as in a single production step, as required by legislation, it is not possible to control the percentages of ingredients introduced into the mixer with sufficient precision and, furthermore, it is not even possible to guarantee production with standard characteristics over time.

To overcome such drawbacks and to be able to produce structural concrete according to related legislation, it is known to use “batch” type concrete mixing plants, commonly defined as “batch plants”, which are configured for the production of a predefined number of batches of structural concrete, wherein the production steps are separated into the dosing, loading, mixing and unloading steps.

Batch plants enable the production of all types of concrete, as there is forced stirring, it being possible to decide how long the product is to be mixed for, and also the degree of slump of the material no longer having an influence.

However, batch systems require large mixers to guarantee hourly productions of concrete that are comparable with those of continuous plants, with a consequent increase in the plant costs and electrical consumptions.

### SUMMARY

In this context, the technical task underpinning the present invention is to propose a plant for conveying material for the production of structural concrete and a process for conveying material for the production of structural concrete, which obviate the drawbacks of the prior art cited above.

In particular, an object of the present invention is to provide a plant for conveying material for the production of structural concrete able to guarantee high hourly productions of structural concrete, comparable to the hourly productions of continuous plants.

Another object of the present invention is that of providing a plant for conveying material for the production of structural concrete able to limit energy consumption and, therefore, use reduced power levels.

A further object of the present invention is that of providing a plant for conveying material for the production of structural concrete having a simple structure, which is not bulky and is simple to design.

An object of the present invention is that of providing a plant for conveying material for the production of structural concrete and a process for conveying material for the production of structural concrete, wherein the amount of ingredients required respects the tolerance limits set by legislation in force with maximum precision.

The stated technical task and specified objects are substantially reached by a plant for conveying material for the production of structural concrete and a process for conveying material for the production of structural concrete, which comprise the technical features disclosed in the independent claims. The dependent claims correspond to further advantageous aspects of the invention.

It should be highlighted that this summary introduces, in simplified form, a selection of concepts which will be further elaborated in the detailed description given below.

The invention relates to a plant for conveying material for the production of structural concrete.

The same plant may also be used for producing other artificial conglomerates, e.g. based on mixing cement, filler, fly ash, silica, ash, or other powdered materials.

In particular, the plant comprises a first container configured to contain a first amount of material which is variable between a first minimum reference amount and a maximum one and, furthermore, having its own loading opening and its own unloading opening for the first amount of material. A first detection member is associated with the first container and is configured to detect a variation in the first amount of material. Additionally, first release members connected to the unloading opening of the first container are configured to enable and/or disable the release towards a mixing area of the first amount of material.

The plant also comprises a second container configured to contain a second amount of material which is variable between a second minimum reference amount and a maximum one and, furthermore, having its own loading opening and its own unloading opening for the second amount of material. A second detection member is associated with the second container and is configured to detect a variation in the second amount of material. Additionally, second release members connected to the unloading opening of the second container are configured to enable and/or disable the release towards a mixing area of the second amount of material.

In particular, the unloading opening of the second container is connected to the mixing area in order to release the second amount of material therein. The unloading opening of the first container, instead, can be connected to the loading opening of the second container for releasing the first amount of material therein (so as to define a serial configuration), or it can be connected to the mixing area to release the first amount of material therein (so as to define a parallel configuration).

The plant further comprises a control unit configured at least to enable the first release members to release the first amount of material when the second detection member detects the reaching of the second minimum reference amount in the second container.

In other words, the plant is configured to substantially continuously convey towards a relevant mixing area the necessary materials for the production of structural concrete (or another artificial agglomerate) in order to obtain continuous production and not a single limited batch.

In particular, the plant enables the following advantages to be obtained:
high hourly production rates comparable with known continuous production plants;
production of structural concrete wherein the amounts of the various materials are comprised within the limits imposed by legislation in force (the dosing errors of the plant are comprised between 0% and 1%, when the maximum limit set by legislation is equal to 3%);
use of reduced power levels for operating the plant;
use of light support structures with extension of the plant on the ground.

The invention also relates to a process for conveying material for the production of structural concrete.

In particular, the process comprises the following steps:
filling a first container having its own loading opening and unloading opening with a first amount of material until reaching a pre-established reference amount;
detecting a variation in the first amount of material at least between a first minimum and maximum reference amount;
releasing at least part of the first amount of material from the unloading opening;
filling a second container having its own loading opening and unloading opening with a second amount of material until reaching a pre-established reference amount;
detecting a variation in the second amount of material at least between a second minimum and maximum reference amount;
releasing at least part of the second amount of material from the unloading opening;
connecting the unloading opening of the second container to a mixing area in order to release the second amount of material therein
connecting the unloading opening of the first container to the loading opening of the second container for releasing the first amount of material therein so as to define a serial configuration, or to the mixing area to release the first amount of material therein so as to define a parallel configuration.

Advantageously, the steps of releasing the respective part of the amount of material are carried out so as to perform a substantially continuous supply of material into the mixing area.

Even more advantageously, the aforesaid process enables a continuous concrete mixing process to be implemented for the production of high amounts of structural concrete and, at the same time, structural concrete to be obtained which has the typical dosing precision of typical concrete mixing processes of “batch” type plants.

### BRIEF DESCRIPTION OF THE DRAWINGS

Further characteristics and advantages of the present invention will become clearer from the indicative, and therefore non-limiting, description of a preferred but not exclusive embodiment of a plant for conveying material for the production of structural concrete, as illustrated in the attached drawings, in which:

FIG. 1 is a schematic view of a plant for conveying material for the production of concrete according to the prior art;

FIG. 2 is a schematic view of a first embodiment of a plant for conveying material for the production of structural concrete;

FIG. 3 is a schematic view of a second embodiment of a plant for conveying material for the production of structural concrete;

FIG. 4 is a schematic view of a third embodiment of a plant for conveying material for the production of structural concrete;

FIG. 5 is a schematic view of a fourth embodiment of a plant for conveying material for the production of structural concrete.

With reference to the drawings, they serve solely to illustrate embodiments of the invention with the aim of better clarifying, in combination with the description, the inventive principles on which the invention is based.

### DETAILED DESCRIPTION

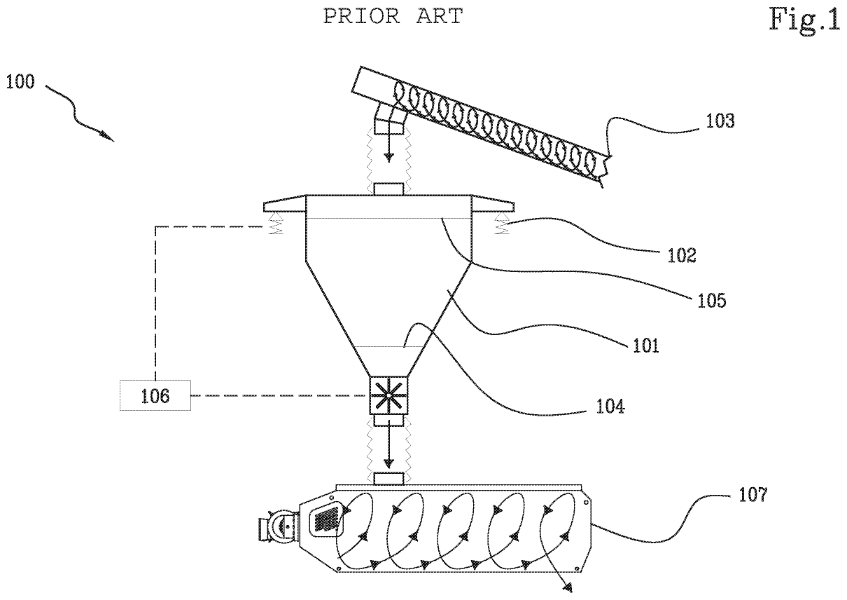

FIG. 1 illustrates a concrete mixing plant 100 for the continuous production of concrete according to the prior art.

Such concrete mixing plant 100 comprises a hopper 101 installed on weighing cells 102 configured to monitor the amount of cement contained inside the hopper 101 itself and the introduction thereof through reloading systems 103, including rotary valves, dosing screws . . . .

The detection of the increase or decrease in weight of the hopper 101 by the weighing cells 102 enables the reaching of the minimum 104 or maximum level 105, respectively, of cement inside the hopper 101 itself to be detected, in order to handle the conveying of the latter from the storage container (generally a silo) by means of the aforesaid reloading systems 103.

However, the main drawback of the aforesaid continuous concrete mixing system 100 for which the production of structural concrete does not appear to be sufficient is the presence of a so-called “dark time” in which it is not possible to detect the decrease in weight of the hopper 101 because of the simultaneous reloading thereof.

In other words, until the cement has filled the hopper 101 again up to its maximum level 105, the concrete mixing plant 100 is not able to guarantee that the values of the amounts of cement of the concrete recipe are within the tolerance limits required by legislation.

Therefore, the concrete mixing plant 100 is necessarily provided with a screw or another very large and expensive system for reloading from a silo in order to reduce this “dark” time of the continuous cycle.

FIG. 1 further illustrates the presence of a control unit 106 configured to enable the passage of cement towards the mixing area 107 as a function of the detection of the weighing cells 102.

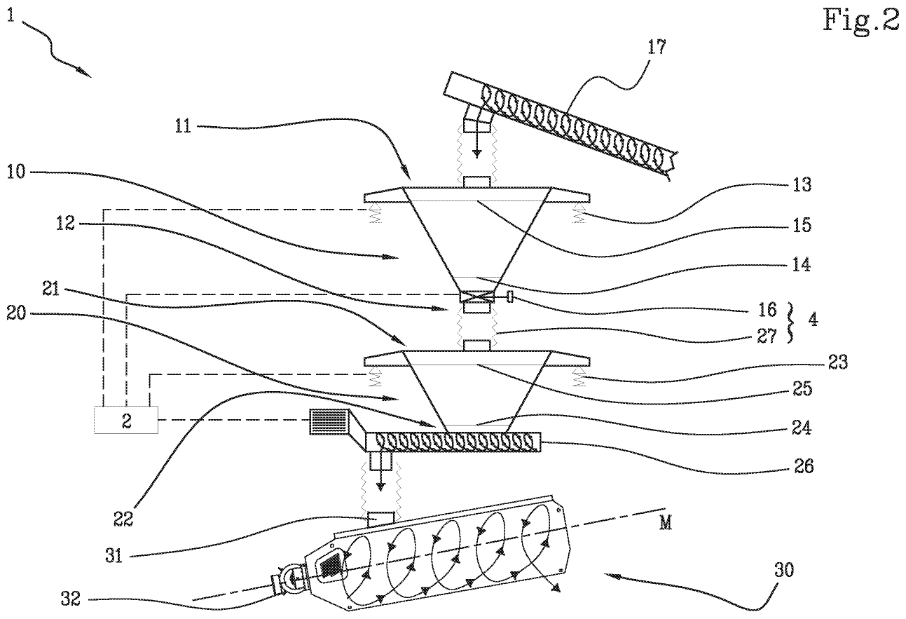

The remaining FIGS. 2, 3, 4, 5 show different embodiments of a plant for the production of structural concrete according to the invention described herein.

In particular, the plant has been generically indicated by number 1. The other numerical references refer to technical features of the invention which, barring indications otherwise or evident structural incompatibilities, the person skilled in the art will know how to apply to all the variant embodiments described.

Any modifications or variants which, in the light of the description, are evident to the person skilled in the art, must be considered to fall within the scope of protection established by the present invention, according to considerations of technical equivalence.

In particular, the plant 1 comprises a first container 10 configured to contain a first amount of material which is variable between a first minimum reference amount 14 and a maximum one 15 and, furthermore, having its own loading opening 11 and its own unloading opening 12 for the first amount of material. A first detection member 13 is associated with the first container 10 and is configured to detect a variation in the first amount of material. Additionally, first release members 16 connected to the unloading opening 12 of the first container 10 are configured to enable and/or disable the release towards a mixing area 30 of the first amount of material.

The plant 1 also comprises a second container 20 configured to contain a second amount of material which is variable between a second minimum reference amount 24 and a maximum one 25 and, furthermore, having its own loading opening 21 and its own unloading opening 22 for the second amount of material. A second detection member 23 is associated with the second container 20 and is configured to detect a variation in the second amount of material. Additionally, second release members 26 connected to the unloading opening 22 of the second container 20 are configured to enable and/or disable the release towards a mixing area 30 of the second amount of material.

In particular, the unloading opening 22 of the second container 20 is connected to the mixing area 30 in order to release the second amount of material therein. The unloading opening 12 of the first container 10, instead, can be connected to the loading opening 21 of the second container 20 for releasing the first amount of material therein (so as to define a serial configuration), or it can be directly connected to the mixing area 30 to release the first amount of material therein (so as to define a parallel configuration).

The plant 1 further comprises a control unit 2 configured at least to enable the first release members 16 to release the first amount of material when the second detection member 23 detects the reaching of the second minimum reference amount 24 in the second container 20.

Advantageously, the aforesaid plant 1 makes it possible to obtain a comparable production of structural concrete to that which can be obtained with the continuous plants known in the state of the art and, at the same time, with the dosing precision of the various materials typical of batch type plants, also known in the state of the art.

In fact, the present plant 1 enables the necessary times for reloading the mixing area 30 with the necessary materials for producing structural concrete to be notably reduced and, furthermore, with high dosing precision of the same materials in order to respect the so-called “recipe” of the concrete and the tolerance limits set by legislation, within which the so-called dosages can undergo minimal variations (3% maximum).

In practice, the plant 1 enables the reloading times to be reduced (also known as “dark time) to just a few seconds rather than the few minutes of the prior art, advantageously until the cancellation thereof.

Preferably, the first container 10 and the second container 20 comprise respective hoppers.

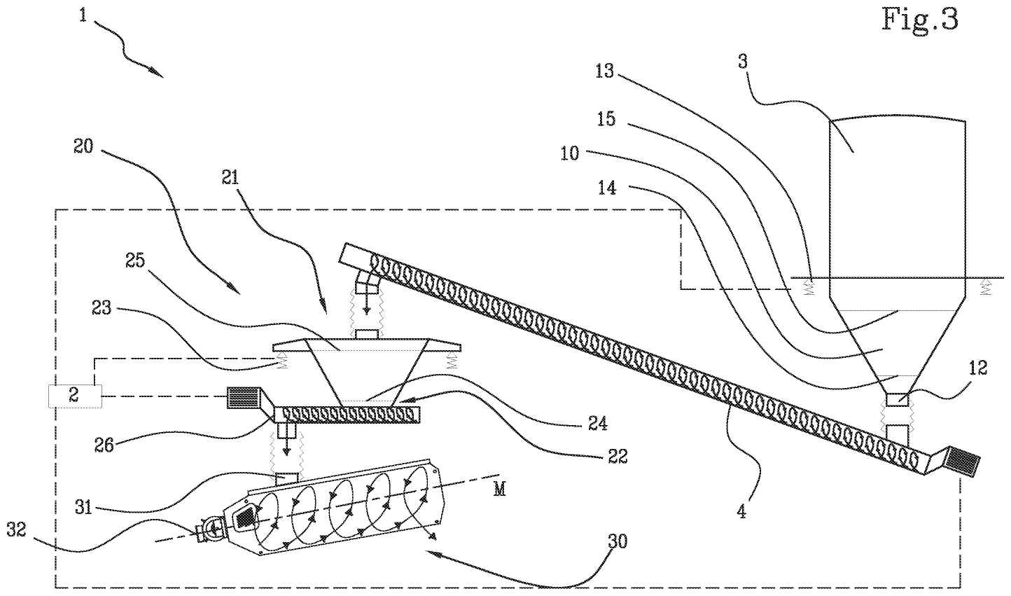

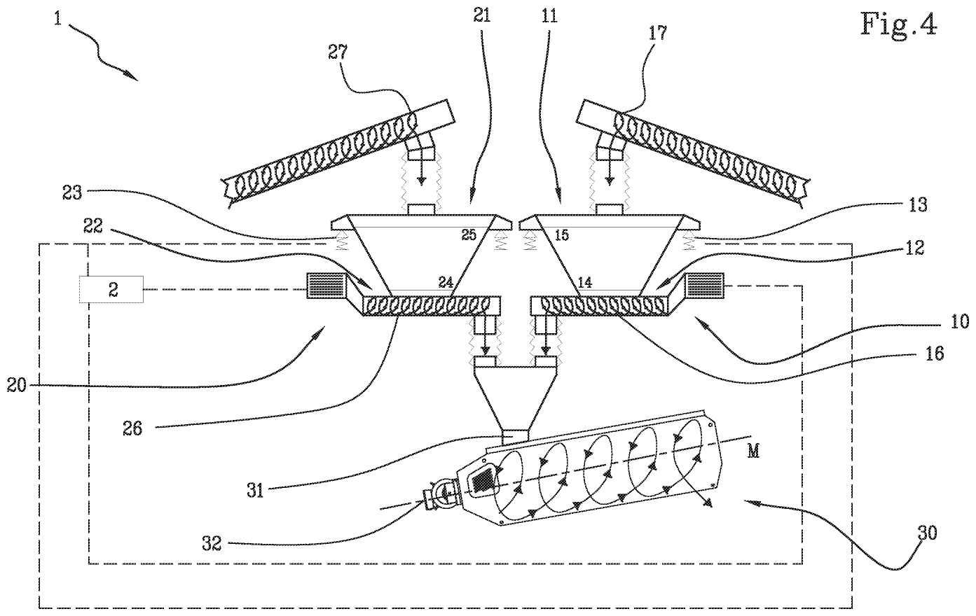

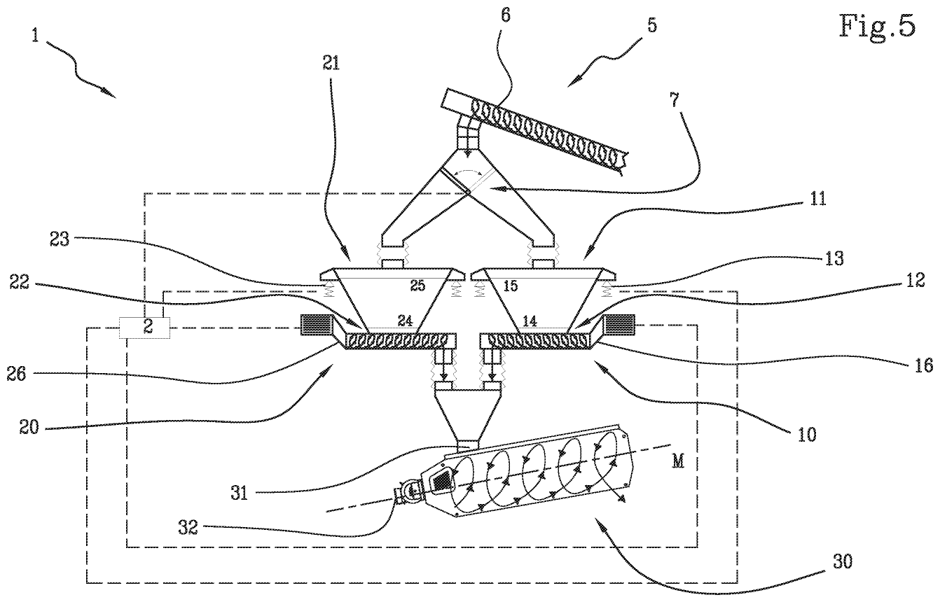

According to one aspect of the invention, the control unit 2 is configured to:
enable the second release members 26 to continuously release the second amount of materials in the serial configuration (FIGS. 2 and 3), or
enable the second release members 26 and the first release members 16 to alternately release the respective amount of materials in the parallel configuration (FIGS. 4 and 5).

In other words, according to the connection of the unloading opening 12 of the first container 10, it is possible to configure the plant 1 between a serial or a parallel configuration.

According to another aspect of the invention, the first and the second detection members 13, 23 are configured to detect the variation in the respective amount of material continuously over time.

In this way, the detection members 13, 23, preferably, of the scales, are able to constantly detect the variation in the respective amount of material and send such detection to the control unit 2.

According to one aspect of the invention visible in FIGS. 2 to 5, the plant 1 comprises first and second loading members 17, 27, preferably screws, associated with the respective unloading opening 11, 21 and configured to enable and/or disable the loading from a storage area 3 or from a storage container of the respective amount of material.

According to one aspect of the invention, the control unit 2 is configured at least to enable the first and/or the second loading members 17, 27 to load the first and/or the second amount of material when the first and/or the second detection member 13, 23 has/have detected the respective first and/or second minimum reference amount 14, 24.

In other words, each container 10, 20 is loaded with the respective amount of material wherein the respective detection members 13, 23 detect the reaching of the respective minimum reference amount 14, 24.

According to another aspect of the invention, the control unit 2 is configured to alternate the enabling of the first release members 16 and of the first loading members 17.

In other words, when the first loading members 17 are enabled for loading the first amount of material into the first container 10, the first release members 16 are disabled. Vice versa, when the first release members 16 are enabled for unloading the first amount of material from the first container 10, the first loading members 17 are disabled.

In this way, the first container 10 can be loaded with a first known amount of material in a precise way thanks to the simultaneous detection operated by the first detection members 13.

In other words, during the unloading of the second amount of materials from the second container 20, the first container 10 is able to act as a “reserve” container (like in a batch type plant). Additionally, given that during the unloading of the first container 10 its loading is disabled, the plant 1 through the control unit 2 can find out the exact amount of material unloaded as it is correctly detected by the first detection members 13.

In the event in which the containers 10, 20 are in the serial configuration, the known first amount of unloaded materials (preferably coinciding with the maximum reference amount 15, but also with a lower or slightly higher value—the first detection members 13 enable the value of such amount to be known precisely) will be conveyed into the second container 20. Otherwise, in the event in which the containers 10, 20 are in the parallel configuration, the known first amount of materials will be unloaded directly into the mixing area 30 and, preferably, in an alternate way to the second amount of materials contained in the second container 20.

According to a further aspect of the invention, the control unit 2 is configured to alternate the enabling of the first and the second loading members 17, 27 so as to alternatively load one container or the other 10, 20.

For each aspect of the invention illustrated in FIGS. 2 to 5, it follows that it is preferable to load each container 10, 20 alternately with respect to the other container 20, 10.

According to a first aspect of the invention illustrated in FIGS. 2 and 3, the first release member 16 and the second loading member 27 define a single transfer member 4, preferably a valve element or a screw, in the serial configuration.

More precisely, FIGS. 2 and 3, respectively, illustrate a first and a second embodiment of the plant 1 wherein the unloading opening 12 of the first container 10 is directly connected to the loading opening 21 of the second container 20 for unloading the first amount of material into the latter.

In other words, the two containers 10, 20 are arranged in series with one another so that during the release of the material through the unloading opening 12 of the first container 10, the second container 20 can be filled between the respective minimum reference amount 14 and the maximum one 15, so that the plant 1 can produce structural concrete substantially continuously and, at the same time, guarantee respect for the concentrations required by legislation.

According to an aspect of the invention, the control unit 2 is configured to simultaneously enable the first and the second release members 16, 26 for a predefined time interval.

Preferably, the simultaneous enabling of the release members 16, 26 takes place for a time interval of less than a quarter of a minute, even more preferably of the maximum duration of 2 seconds.

According to another aspect of the invention, the control unit 2 is configured to:
receive from the first detection members 13 a value identifying the first amount of material released from the first container 10 into the second container 20;
dose the release of the second amount of material from the second container 20 into the mixing area 30 by enabling the second release member 26.

In other words, the second release member 26 is configured to dose the release of the second amount of materials towards the mixing area 30 as a function of the value (known thanks to the first detection members 13) of the first amount of materials transferred from the first container 10 to the second container 20.

In fact, the control unit 2 can adjust the operation of the second release member 26, preferably a screw, as a function of the value sent to it by the first detection members 13 so as to respect the necessary dosing for the correct formation of the structural concrete (i.e. to remain within the tolerance limits set by legislation). During the release of the first amount of material into the second container 20, given the superposition in the enabling of the first and second release members 16, 26, it is possible for the second detection members 23 not to be able to detect the exact amount of materials present in the second container 20 (“dark time” reduced to the absolute minimum necessary thanks to the pre-loading of the first container 10). Thanks to the exact detection carried out by the first detection members 13 during the pre-loading of the first container 10, the control unit 2 is advantageously able to overcome the lack of information during the so-called “dark time” and respect the required dosages for the structural concrete “recipe”.

In other words, the control unit 2 is advantageously able to handle the dosage that takes place between the first container 10 and the second container 20 by counting the reloading time and the amount of material transferred through the detection of the weight difference detected by the first detection members 13. Therefore, the control unit 2 is advantageously able to correct the dosage flow (the amount of material transferred per unit of time) leaving the second container 20 through the second release members 26 in order to respect the proportions that affect the various ingredients of the predefined structural concrete recipe.

The reloading time is influenced by many factors, including:
inlet rate of the loading and/or release members;
capacity of the containers;
amount of material to transfer (dependent on the capacity of the containers or the number of reloading steps to implement);
type of dosed material (cement, filler, or fly-ash).

Therefore, the control unit 2 is advantageously able to control the aforesaid known parameters as they can be derived directly from the design of the plant 1. It follows that the dosing of the materials into the mixing area 30 is therefore modulated, as the missing information can be easily derived from the data detected and/or known, unlike what happens according to the prior art.

According to a preferred embodiment of the invention illustrated in FIG. 2, the first container 10 is arranged on top of the second container 20 with respect to a same vertical direction.

In this way, the first container 10 releases by gravity the first amount of material into the second container 20 by enabling the first release member 16, preferably a rotary valve or a butterfly valve.

Even more preferably, the first release member 16 is configured to totally prevent the passage of the first amount of material, or to enable the total passage, or to dose the passage thereof.

According to an alternative second embodiment of the invention illustrated in FIG. 3, the plant 1 comprises a silo in which the first container 10 is comprised. In particular, the first detection member 13 is configured to detect a variation in the first amount of material contained inside the silo.

In other words, the silo defines the storage area 3, which is arranged in direct communication with the first container 10.

In other words, the silo in which the materials are normally contained for the production of structural concrete, e.g. cement, is provided with a hopper (the first container 10) preferably arranged at a lower portion thereof so as to distribute the first amount of material towards the second container 20 (arranged below or adjacent). Additionally, the silo comprises the first detection member 13 configured to detect the variation in the amount of material contained and, therefore, to enable correct conveying by the first release member 16, preferably a rotary valve and/or a screw. According to a second aspect of the invention illustrated in FIGS. 4 and 5, the control unit 2 is configured to alternate the enabling of the first and second release members 16, 26.

More precisely, FIGS. 4 and 5 illustrate a third and a fourth embodiment of the plant 1, respectively, wherein the unloading opening 12 of the first container 10 and the unloading opening 22 of the second container 20 are directly connected to the mixing area 30 for unloading, in an alternate way, the first and the second amount of material into the latter.

Therefore, in other words, the third and the fourth embodiment envisage the two containers 10, 20 being able to operate in parallel with one another.

Like the serial embodiments, until one of the two containers 10, 20 is filled between its own minimum reference amount 14, 24 and the maximum one 15, 25, the other container 20, 10 is enabled to release its own amount of material into the mixing area 30 so as to guarantee the continuous production of structural concrete and, at the same time, guarantee the precise measurement of the amounts of materials added in order to comply with legislation in force.

According to one aspect of the invention, the control unit 2 is configured to:
receive from the first detection members 13 a value identifying the first amount of material loaded into the first container 10;
receive from the second detection members 23 a value identifying the second amount of material loaded into the second container 20;
dose the release from each container 10, 20 of the respective amount of material into the mixing area 30 by enabling the first or the second release member 16, 26.

In other words, each release member 16, 26 is configured to dose the release of the respective amount of materials towards the mixing area 30 as a function of the value (known thanks to the first or second detection members 13, 23) of the first or second amount of materials transferred from each container 10, 20 to the mixing area 30.

In fact, the control unit 2 can adjust the operation of each release member 16, 26, preferably a screw, as a function of the value sent to it by the first or second detection members 13, 23 so as to respect the necessary dosing for the correct formation of the structural concrete (i.e. to remain within the tolerance limits set by legislation).

According to one aspect of the invention illustrated in FIG. 4, the plant 1 comprises a first loading member 17 associated with the loading opening 11 of the first container 10 for conveying the first amount of material and a second loading member 27 associated with the loading opening 21 of the second container 20 for conveying the second amount of material.

FIG. 4 illustrates the third embodiment of the invention, wherein the first and the second loading member 17, 27 are distinct and configured to transfer an amount of material from a storage area 3 towards the respective container 10, 20. In particular, the first and the second loading member 17, 27 may be associated with the same storage area 3 or with different storage areas 3.

According to an alternative aspect of the invention illustrated in FIG. 5, the loading members 17, 27 coincide with one another in a single filling member 5 comprising a dosing screw 6 and a diverter element 7 arranged downstream of the dosing screw 6. In particular, the diverter element 7 can be configured between a first operating position, in which it places in connection the dosing screw 6 and the first container 10, and a second operating position, in which it places in connection the dosing screw 6 and the second container 20.

In other words, FIG. 5 illustrates the fourth embodiment of the plant 1 comprising a single filling member 5 interposed between the storage area 3 and both the containers 10, 20. In particular, according to the first embodiment, the single filling member 5 comprises a diverter element 7 configured to alternate the conveying of an amount of material between the loading openings 11, 21 of the first and the second container 10, 20 preferably after the first or the second detection members 13, 23 have detected the reaching of the respective minimum reference amount 14, 24. According to a further aspect of the invention, the control unit 2 is configured to alternate the diverter element 7 from the first operating position to the second operating position when, respectively, the second detection member 23 has detected the minimum reference amount 24 and, vice versa, the first detection member 13 has detected the minimum reference amount 14.

In other words, until the first release member 16 is enabled to release the first amount of material, the diverter element 7 is configured to convey an amount of material into the second container 20 through the respective loading opening 21 so as to preferably fill it to about the maximum reference amount 25 and, at the same time, disabling the second release member 26 from releasing the second amount of material.

Therefore, when the first container 10 must be filled so that the material preferably reaches the respective maximum reference amount 15, the diverter element 7 is configured to convey from the storage area 3 the material into the first container 10 (in which the first release member 16 has been disabled from releasing material), while the second container 20 releases the second amount of material into the mixing area 30.

According to one aspect of the invention visible in FIGS. 2 to 5, the mixing area 30 comprises a dual-axis rotational mixer configured to make the materials continuously conveyed therein advance along a mixing direction M (both through the containers 10, 20 and through other sources, such as water from a source), mixing them for a sufficient time and adapted to obtain a sufficiently uniform concrete.

According to one aspect of the invention, the mixer comprises a box-shaped body which extends along the mixing direction M to define the mixing area 30, on which there is at least a first inlet mouth 31 useful for introducing the material coming from the first and from the second container 10, 20 and at least a second inlet mouth 32 useful for introducing the necessary amount of water for producing the structural concrete.

Preferably, inside the box-shaped body one or more rotary shafts are provided, which are arranged parallel to one another and to the mixing direction M. Each rotary shaft is configured to rotate about its own extension axis parallel to the mixing direction M. Preferably, each rotary shaft is equipped with a plurality of blades arranged along almost the entire length of the respective rotary shaft and radially with respect thereto. Advantageously, the positioning of the blades can be adjusted according to one or more degrees of freedom so as to be able to vary the inclination relative to the mixing direction M. In this way, the blades are able to vary their volumetric dimensions inside the mixer and, therefore, the effective extension of their own mixing surface in order to vary the speed at which the materials are mixed together and, additionally, also their advancement speed along the mixing direction M as a function of the type of structural concrete to be obtained (i.e. according to the homogeneity value and/or final slump factor to be obtained).

According to another aspect of the invention, the plant 1 comprises a water dosing apparatus which can enable the production of concrete on the ground and, therefore, the subsequent transfer thereof to height, e.g. in a truck mixer or the like.

In particular, the water dosing apparatus comprises a first mixer configured to mix at least a first amount of water and cement in order to make concrete with low fluidity having a consistency class (or slump factor) less than or equal to “S2” and a second mixer having a loading section configured and arranged so as to receive the low fluidity concrete coming from the first mixer.

Preferably, the first mixer defines the aforesaid mixing area 30 and has an outlet section arranged at a predetermined expulsion level with respect to a horizontal reference plane and adapted to eject the low fluidity concrete, whereas the second mixer is configured to mix the low fluidity concrete produced by the first mixer with a second amount of water so as to make a fluid concrete having a consistency class (or slump factor) greater than or equal to “S2”.

Even more preferably, the water dosing apparatus comprises a water supply means configured to supply a first amount of water towards the first mixer and a second amount of water towards the second mixer.

In other words, the provision in series of two mixers enables fluid concrete to be made having a higher consistency class “S” with respect to that of the low fluidity concrete made in the first mixer only, simply by adding, according to doses predefined by corresponding recipes, a second amount of water to the low fluidity concrete coming from the first mixer. Advantageously, by further supplying the second mixer (for example a truck mixer adapted to transport the concrete in situ) with low fluidity concrete rather than with powdered cement it is possible to prevent the dispersion of dust and reduce the mixing times, since the low fluidity concrete is already pre-stirred by the first mixer.

Even more advantageously, the mixing of the concrete with a reduced dose of water by the first mixer enables a more uniform mixture to be obtained which can be mixed more efficiently.

The present invention also relates to a process for conveying material for the production of structural concrete.

In particular, the aforesaid process comprises the following steps:
filling a first container 10 having its own loading opening 11 and unloading opening 12 with a first amount of material until reaching a pre-established reference amount;
detecting a variation in the first amount of material at least between a first minimum and maximum reference amount 14, 15;
releasing at least part of the first amount of material from the unloading opening 12;
filling a second container 20 having its own loading opening 21 and unloading opening 22 with a second amount of material until reaching a pre-established reference amount;
detecting a variation in the second amount of material at least between a second minimum and maximum reference amount 24, 25;
releasing at least part of the second amount of material from the unloading opening 22;
connecting the unloading opening 22 of the second container 20 to a mixing area 30 in order to release the second amount of material therein;
connecting the unloading opening 12 of the first container 10 to the loading opening 21 of the second container 20 for releasing the first amount of material therein so as to define a serial configuration, or to the mixing area 30 to release the first amount of material therein so as to define a parallel configuration.

Advantageously, the steps of releasing the respective part of the amount of material from the respective container 10, 20 are carried out so as to perform a substantially continuous supply of the material into the mixing area 30.

In other words, the process enables continuous production of structural concrete, whereas in the state of the art it is produced with a batch type process to guarantee the correct doses of the materials according to legislation in force.

Substantially, as long as the second container 20 releases a second amount of materials into the mixing area 30, the first container 10 is filled with a first amount of materials up to about a maximum reference amount 15.

Upon reaching the minimum reference amount 14 of the second container 20, the process envisages filling the aforesaid second container 20 with the first reference amount present in the first container 10. Such first amount of material varies between about the minimum reference amount 14 and about the maximum reference amount 15 and, preferably, will be equal to the maximum reference amount 15.

Advantageously, this filling step lasts a few seconds (previously defined as “dark time”) and enables the amount of material transferred between the first and the second container 10, 20 to be known with precision. Therefore, in this way, it is possible to correct the initial release of material into the mixing area 30 to compensate for the “dark interval” which lasts a few seconds during which there has been no transfer.

Alternatively, it is possible that the first container 10 releases the first amount of materials directly into the mixing area 30 and, at the same time, that the second container 20 is filled again up to the maximum at about its own maximum reference quantity 25 with material coming from a storage area 3, e.g. a silo.

According to one aspect of the invention, the steps of filling a first container 10 and filling a second container 20 are carried out alternatively to one another.

According to another aspect of the invention, the steps of releasing the respective part of the amount of material are carried out simultaneously to one another for a predefined time interval.

Preferably, such steps are carried out simultaneously for a time interval of less than a quarter of a minute, even more preferably of the maximum duration of 2 seconds.

According to a further aspect of the invention, the steps of releasing the respective part of the amount of material are carried out alternatively to one another.

According to a preferred embodiment, therefore, the steps of filling a first container 10 and of releasing at least part of the second amount of material are carried out substantially simultaneously to one another.

Likewise, the steps of filling a second container 20 and releasing at least part of the first amount of material are substantially carried out simultaneously to each other and alternatively to the pair of steps previously mentioned.

1.-13. (canceled)

14. A plant for conveying material for the production of structural concrete, comprising:
a first container comprising a hopper and configured to contain a first amount of material varying between a first minimum and a first maximum reference amount, said first container having a loading opening and an unloading opening for the first amount of material;
a first detection member associated with the first container and configured to detect a variation in the first amount of material;
first release members connected to the unloading opening of the first container and configured to enable and/or disable release of the first amount of material towards a mixing area;
a second container comprising a hopper and configured to contain a second amount of material varying between a second minimum and a second maximum reference amount, said second container having a loading opening and an unloading opening for the second amount of material;
a second detection member associated with the second container and configured to detect a variation in the second amount of material;
second release members connected to the unloading opening of the second container and configured to enable and/or disable release of the second amount of material towards a mixing area;
wherein said unloading opening of the second container is connected to the mixing area so as to release therein the second amount of material; said unloading opening of the first container being connected:
to said loading opening of the second container so as to release therein the first amount of material, thus defining a serial configuration; wherein a control unit is configured:
at least to enable said first release members to release the first amount of material when said second detection member detects the arrival of the second minimum reference amount in the second container,
to receive from said first detection members a value identifying the first quantity of material released from said first container into said second container;
to dose the release from the second container of the second quantity of material into the mixing area through the enabling of said second release member as a function of the identification value detected by at least one of: said first detection members and said second detection members, wherein said control unit is configured to enable said second release members to release the second amount of materials continuously over time, in the serial configuration.

15. The plant according to claim 14, wherein said first and second detection members are configured to detect the variation in the respective amount of material continuously over time.

16. The plant according to claim 14, comprising first and second loading members associated with the respective loading opening and configured to enable and/or disable loading of the respective amounts of material from a storage area or from a storage container.

17. The plant according to claim 16, wherein said control unit is configured at least to enable at least one of: said first loading members and second loading members to load at least one of: the first amount of material and the second amount of material when at least one of: said first detection member and second detection member has detected the respective at least one of: first minimum reference amount and second minimum reference amount.

18. The plant according to claim 17, wherein said control unit is configured to alternate the enabling of said first release members and said first loading members.

19. The plant according to claim 16, wherein said control unit is configured to alternate the enabling of said first loading members and second loading members so as to alternately load one container or the other container.

20. The plant according to claim 16, wherein said first release member and said second loading member define a single transfer member in the series configuration.

21. The plant according to claim 20, wherein said control unit is configured to simultaneously enable said first release members and second release members for a predefined interval of time.

22. The plant according to claim 14, wherein said first container is positioned above said second container relative to a same vertical direction.

23. A process for conveying material for the production of structural concrete, comprising the following steps:
filling a first container having a loading opening and an unloading opening with a first amount of material until reaching a pre-established reference amount;
detecting a variation in said first amount of material at least between a first minimum and a first maximum reference amount;
releasing at least part of said first amount of material from said unloading opening through first release members connected to the unloading opening of the first container;
filling a second container having a loading opening and an unloading opening with a second amount of material until reaching a pre-established reference amount;
detecting a variation in said second amount of material at least between a second minimum and a second maximum reference amount;
releasing at least part of said second amount of material from said unloading opening through second release members connected to the unloading opening of the second container;
connecting said unloading opening of the second container to a mixing area so as to release therein the second amount of material;
connecting said unloading opening of the first container to said loading opening of the second container so as to release therein the first amount of material, thus defining a serial configuration;
wherein said steps of releasing the respective part of the amount of material are carried out in such a way as to achieve a substantially continuous feeding of material into said mixing area;
enabling said second release members to release the second amount of material continuously over time, in the serial configuration.

24. The process according to claim 23, wherein said steps of filling a first container and of filling a second container are carried out in a mutually alternating manner.

25. The process according to claim 23, wherein said steps of releasing the respective part of the amount of material are carried out simultaneously for a predefined time interval.
